(19) United States
(12) Patent Application Publication
(10) Pub. No.: US 2025/0054423 A1
(43) Pub. Date: Feb. 13, 2025

(54) Display and AI (Artificial Intelligence) Methods for a Near-Eye Display System

(71) Applicant: Kopin Corporation, Westborough, MA (US)

(72) Inventors: Michael Murray, Middleton, MA (US); Hongmei Zhang, Lexington, MA (US); Ethan Sun, Medford, MA (US); Timothy Hogan, Allen, TX (US); Michael James Hoppe, Vista, CA (US); Benjamin Ivaldi, Bridgewater, MA (US)

(21) Appl. No.: 18/799,204

(22) Filed: Aug. 9, 2024

Related U.S. Application Data
(60) Provisional application No. 63/518,646, filed on Aug. 10, 2023.

(51) Int. Cl. G09G 3/00; G06F 3/01

(52) U.S. Cl. CPC G09G 3/001; G06F 3/013; G09G 2320/0626; G09G 2354/00

(57) ABSTRACT

A display system may comprise an array of pixels arranged to display an image and one or more imaging sensors. Each imaging sensor may be arranged with at least one pixel of the array. The display system may further comprise at least one communication line to provide an image to the array of pixels and to output the sensed data of the plurality of imaging sensors. The display system may further comprise an array of non-visible light quantum dots. The array non-visible light quantum dot may be arranged with the array of pixels such that each quantum dot converts light from the array of pixels to emissions in a non-visible light wavelength range. The display system may further comprise a one or more sensor pixels sensitive to light in the non-visible light wavelength range.

### RELATED APPLICATION

This application claims the benefit of U.S. Provisional Application No. 63/518,646, filed on Aug. 10, 2023. The entire teachings of the above application are incorporated herein by reference.

### BACKGROUND

The significant growth of near-eye display applications in gaming, medical, automotive, and defense applications is coupled to significant technical breakthroughs in display technologies enabling 3 million nits. In turn, there is a need for real time and inferred image sizing, brightness, resolution, and contrast controls. Furthermore, many “see through” augmented reality (AR) and virtual reality (VR) applications suffer from lack of dynamic controls.

### SUMMARY

In some embodiments, disclosed herein is a display system having a microlens array and pixels in the same plane.

In some embodiments, disclosed herein is a sensor and pixel in the same physical plane, such that the focus plane of the projection of the display pixels is a different plane than the focus plane of the sensor.

In some embodiments, disclosed herein is a display system that integrates sensor, display pixels and Infrared (IR) illumination pixels in the same physical plane to improve pupil and iris image capture

The IR illumination may be obtained from, for example, applying an infrared quantum dots layer via spin coating or other solution process above blue OLED, or blue micro-LED pixels layer. While blue light sources are used in some example embodiments herein, other color light sources, as well as a white source, may also be used. These infrared quantum dots may comprise materials such as HgSe and HgCdSe, although other materials may alternatively be used. Infrared quantum dots have ability absorb visible light and convert to infrared light (or light of other wavelengths).

In some embodiments, disclosed herein is a display system with an embedded and/or integrated wavefront sensor for vision error measurements.

In some embodiments, disclosed herein is a display system containing image sensor elements sensitive to non-visible wavelengths; quantum dots then used to convert visible or UV light from the display to provide near-visible infrared (NIR) or short-wave infrared (SWIR) illumination for the sensor. The display can provide uniform IR illumination, or it can be used to project specific infrared test patterns onto the eye. For example, in one application, the display can project an infrared grid pattern onto the surface of the eye, and the sensor pixels can detect the reflected image of this grid pattern to map the curvature of the eyeball.

In some embodiments, disclosed herein are methods and systems for target control based on user eye tracking for a user wearing a head-mounted display system. In some embodiments, AI training and retraining can be employed. In some embodiments, these methods and systems are used in combination with a display system having a microlens and pixel in the same plane or sensor and pixel in a same physical plane, such that the focus plane of the projection of the display pixels is a different plane than the focus plane of the sensor.

In some embodiments, disclosed herein are methods and systems for recognizing fight or flight response by a user wearing a head mounted display system and adjusting the display system in a corresponding manner. In some embodiments, these methods and systems are used in combination with a display system having a microlens and pixel in the same plane or sensor and pixel in a same physical plane, such that the focus plane of the projection of the display pixels is a different plane than the focus plane of the sensor.

In some embodiments, disclosed herein are methods and systems for attention detection and/or data gathering in a head-mounted display system. In some embodiments, these methods and systems are used in combination with a display system having a microlens and pixel in the same plane or sensor and pixel in a same physical plane, such that the focus plane of the projection of the display pixels is a different plane than the focus plane of the sensor.

In some embodiments, disclosed herein are methods and systems for vision compensation and/or dominant eye compensation/adjustment with a head-mounted display system. A component that is separate from the display, such as a deformable mirror or liquid lens may be used for such compensation. In some embodiments, these methods and systems are used in combination with a display system having a microlens and pixel in the same plane or sensor and pixel in a same physical plane, such that the focus plane of the projection of the display pixels is a different plane than the focus plane of the sensor.

In some embodiments, this application discloses novel approaches of bi-directional optics using a camera or sensor embedded in the silicon and/or the display module. In some embodiments, inverse optics includes using the optics of the display system in reverse to track the user's pupil movements, size and location.

In some embodiments, the systems and methods described herein improve immersive display systems such as augmented reality (AR) or virtual reality (VR) glasses/displays, helmets, weapon sights, heads-up displays, fighter jet or other vehicle system, targeting systems, or head-worn display. The systems and methods herein can be applied to any of these embodiments, any equivalent of these embodiments, or any combination of these embodiments.

In addition, the below embodiments can be employed separately or in combination. The below disclosed hardware can employ any of the methods of analysis or processing modules also disclosed. In addition, the below described methods of analysis or processing modules can employ any of the below described hardware.

In some embodiments, the display system described herein can be used to compensate for focus or alignment defects in the human visual system. For example, in strabismus, the optical axes of the eyes are not parallel, and in nystagmus, the eyeballs move back and forth involuntarily. In both cases, the result is a limitation in foveation time—the amount of time that the image of interest is aligned to the most visually sensitive region of the retina. The display system described herein can keep the image aligned and stable with respect to the optical axis of each eye, thus increasing foveation time and visual acuity. Furthermore, in conditions such as nystagmus, the eyes are most stable, and visually acuity highest, when the eyes are in convergence. In the real world, this is only possible when the object of interest is close. With the display system described herein, the digital image can be positioned to induce the desired level of binocular convergence, regardless of the distance of the object. As another example, in amblyopia (lazy eye), current treatment methods are imprecise and iterative. The display system described herein can be used to precisely diagnose the nature and magnitude of the binocular misalignment, to simulate the outcome of alignment correction surgery, or as a therapeutic vision aid in and of itself.

Near-eye displays require real time or predictive feedback loops in high performance applications like aircraft heads-up displays (HUDs), helmet vision systems, weapon sights/optics, and gaming AR/VR goggles. This feedback loop from integrated imagers (e.g., cameras) within a display module and/or a silicon wafer can be used for dynamic brightness, contrast, and image controls.

The method and process of tracking the user's pupil size, location and movement in real time or inferred artificially intelligent processing in critical and high-performance applications requires substantial processing power and immediate feedback control loops. Artificially Intelligent (AI) enabled calculations can infer where the pupil currently is, where the pupil will be in the future, what size the pupil is, and what size the pupil will be in the future based on several inputs. These AI enabled calculations enable the system to understand if a targeting system has selected one target, but the user's eye is tracking a second target instead. For example, a fighter pilot may see a MIG fighter and a Eurofighter Typhoon on their display. The automated system can correctly identify friend or foe, but it may make an error and identify both as a friend or both as a foe. However, the fighter pilot may be focused on the MIG fighter as opposed to the Typhoon. From this information, the system can learn that the MIG is viewed by the pilot as a threat and can take that information into account in determining what is labeled as a friend or foe. This could prevent an AI targeting system from recommending targeting a friendly plane, for example.

As augmented and virtual reality headsets and displays create an immersive experience, some users may experience nausea because of a dual-eye diversity phenomenon, which may be defined as two eyes behaving differently to the same stimuli and or having different capabilities so that one eye may be identified as the dominant eye. The dual eye diversity phenomenon assumes that the user has perfect 20/20 vision, when most people do not. This assumption causes lack of customization of the display, which requires the user's brain to adjust to seeing the image on one or both displays that is unlike the real world and is exacerbated by users who have one heavily dominant eye and/or significantly different eye vision health. Fully integrated goggles, helmets, and dual display applications using multiple displays need for a diverse range of controls because manufacturers are unaware of the user's dominate eye characteristics, overall visual capabilities, individual eye defects (right eye vs. left eye vision). With the neural backplane modules described herein, the display system can be adjusted based on the vision of the particular user and prevent the user from feeling sick/motion sickness, etc.

Furthermore, as microdisplay brightness increases to 3.5 million nits (nits or nitere are standard way(s) to measure a display brightness level) dynamic, real time or inferred brightness controls are needed to enable many applications. Measuring the pupil size allows the system to dynamically change the brightness, contrast, and image size for the user.

Tiny eye movements can also hinder the user's ability to discriminate tactile stimuli. Suppression of eye movements before an anticipated tactile stimulus can enhance that same ability to discriminate tactile stimuli. This may reflect that common brain areas and common neural and cognitive resources underlie both eye movements and the processing of tactile stimuli. This is one of the reasons a user may feel ill or nauseous while using AR/VR glasses.

Humans normally scan the environment visually with about two to three large saccades every second. However, even when a person thinks they are fixating a single location, their eyes move. During fixation, three kinds of eye movements occur, and are sometimes called fixational eye movement. The first is a rapid, but small ocular tremor. An ocular tremor or ocular microtremor is a constant, involuntary eye tremor of a low amplitude (e.g., small) and high frequency (e.g., rapid). The second is a slow movement of the eye that is often called drift. The third is the micro-saccade, which happens about two or three times per second. Micro-saccades are a type of saccade, and therefore are quick, simultaneous movement of both eyes between two or more phases of fixation in the same direction. Micro-saccades differ from saccades in their maximum amplitude, having a smaller maximum amplitude than a saccade. Typically, humans are not aware of any of these eye movements. Some micro-saccades bring the eye back after it has drifted away from the fixation location, however, many micro-saccades also take the eye away from the desired fixation location. In other words, micro-saccades do not always correct for drift. Subjects can make micro-saccades to visual targets, and learn to make fewer micro-saccades during fixation, so there is some level of voluntary, conscious control. Both the rate and amplitude of micro-saccades is affected by the locus of attention, the presentation of an irrelevant visual stimulus, and/or a sound. This suggests that micro-saccades—just like large saccades—are part of the active sensing machinery that the brain uses to probe its visual environment.

Some virtual reality (VR) games or applications have the user walking in place or standing still to avoid nausea or motion sickness. Other VR games or applications rely heavily on immersion, which means the user walks from place to place using a thumb stick or by swinging your arms. The latter can help because moving the user's body around some while your environment appears to be moving helps combat motion sickness. As VR and immersion improves, users still feel like their brains and bodies are arguing during what should be a fun experience. As a result, sweating, dizziness, headaches, and even nausea can accompany game choices. The mechanisms that the game chooses to make the user move through the digital world have a significant impact on how the user will physically feel. Another excellent preventative measure in games where you are moving is darkening the screen edges. Further, teleporting the game's character instead of walking helps even more. Many VR titles offer a variety of ways to make the user feel comfortable and lessen the chances of illness. The burden is on the user to learn what helps them feel good physically and seek out those settings to reduce the potential for motion sickness. However, it can be easily seen that seeking out these settings can be a source of friction for user adoption of headsets and games.

Correct set up of a headset is also important. A headset should fit comfortably and should correctly set the eye distance between lenses. This reduces the load on the user's brain. Having the headset positioned on your head properly can alleviate some of the most common motion sickness triggers by making the experience easier to digest. Adjusting the headset fit and the settings ensures the user moves their eyes as little as possible and goes a long way in preventing dizziness and headaches in VR environments. The example display systems described herein can reduce the need for highly accurate setup as it can compensate for these errors.

Lastly, monitoring the user's breathing and the temperature of the user's surroundings can be important. Just as deep breathing or opening a car window can reduce motion sickness symptoms while traveling, similar effects can be had while using VR. Many VR games give a surprisingly high-intensity workout, so body temperature can creep up without realization. Adding a fan to the room during sessions and taking calm, measured breaths helps the user's body stay cool and comfortable.

NeuralDisplay™ is a family of micro light emitting diode displays and organic light emitting diode display family which utilizes embedded image sensors or external image sensors to track and measure the iris and/or pupil. An AI method optimizes and adapt the display's brightness, contrast, image frequency (e.g., refresh rate) and focus depending on the size, location and movement of the user's pupil and retina. This adaptation must happen in near real time which requires significant processing speeds and specialized Artificial Intelligence methods to infer the user's pupil and retina data.

In one aspect, the invention may be a display system that comprises an array of pixels arranged to display an image and one or more imaging sensors. Each imaging sensor may be arranged with at least one pixel of the array. The display system may further comprise at least one communication line to provide an image to the array of pixels and to output the sensed data of the plurality of imaging sensors.

The display system may further comprise at least one predictive artificial intelligence model, running on an embedded processor, to gain biological/physiological insights. The one or more imaging sensors may acquire at least one dynamic feature of an eye of a user and provide the at least one dynamic feature to the predictive artificial intelligence model. The at least one dynamic feature to the predictive artificial intelligence model may produce therefrom at least one user behavior characteristic. The at least one dynamic feature may comprise one or more of gaze duration, saccade velocity, saccade amplitude, fixation duration, smooth pursuit velocity, microsaccade rate, nystagmus frequency, pupil response latency, pupil constriction velocity, pupil dilation velocity, pupil light reflex latency, and blink frequency. The at least one user behavior characteristic comprises one or more of fight or flight response, emotion, tiredness/fatigue, ocular fatigue/eye strain, cognitive load, attention, and stress level.

The display system may further comprise a first optical channel for processing a video signal to a first eye of a user, a second optical channel for processing the video signal to a second eye of the user, and a dual eye processor that processes aspects of the first optical channel and the second optical channel. The first optical channel, the second optical channel, and the dual eye processing channel may utilize artificial intelligence processing techniques. These artificial intelligence processing techniques may include models and algorithms executed by an embedded processor or other such processor known in the art. The artificial intelligence processing techniques may comprise at least one of K-nearest Neighbor, SVM, Hidden Markov Model, Binary decision tree, Naïve Bayes, Random Forest, and convolutional neural network.

In another aspect, the invention may comprise a display system that comprises an array of pixels arranged to display an image, and an array of imaging sensors arranged to operatively detect information from an eye of a user in response to the displayed image of the array of pixels. The array of imaging sensors may be arranged to operatively calibrate, optimize, and/or manage one or more characteristics of the array of pixels. The one or more characteristics may comprise one or both of brightness and contrast. The display system may further comprise an array of infrared illumination pixels, wherein the array of infrared illumination pixels is arranged with the array of pixels such that a quantum dots layer converts light from the array of pixels to emissions in an infrared wavelength spectrum.

The display system may further comprise one or more sensor pixels that are sensitive to light in the non-visible light wavelength range. The array of imaging sensors is overlaid with lens elements or wavefront encoding optics, such that the wavefront encoding optics can provide vision error measurements. The display system may further comprise a first mono-processing channel for processing a video signal to a first eye of a user, a second mono-processing channel for processing the video signal to a second eye of the user, and a dual eye processor that processes aspects of the first mono-processing channel and the second mono-processing channel. The first mono-processing channel, the second mono-processing channel, and the dual eye processing channel may utilize artificial intelligence processing techniques. The first mono-processing channel may be coupled to a display module, and the second mono-processing channel may be coupled to a second display module. The first display module and the second display module may comprise a first array of pixels and a camera. The camera of each display module may collect information associated with the respective eye of the user and convey the information to the respective mono processing channel.

In another aspect, the invention may be a monocular or binocular display system that comprises an electronically controlled mirror, a second mirror, a focusing lens, a microdisplay configured to project an image to the second mirror, such that it is reflected to the focusing lens, an imaging sensor configured to receive images of a pupil reflected off the second mirror and electronically controlled mirror.

A method for determining a target may comprise displaying an environment including a plurality of real-world arguments as captured by an imaging device and observing, using a sensor of a microdisplay in a monocular or binocular display, eye movement including pupil and iris data while displaying a representation of the environment. The method may further comprise determining or verifying, using a processor and based on metrics of the observed eye movement, whether a first real-world object captured by a camera is a target. The method may further comprise updating the display of the environment to indicate the determined or verified target. A second real-world object may be captured by the camera, and the processor may select one of the first real-world object or the second real-world object as more likely being the target.

In another aspect, the invention may be a method for adjusting a monocular or binocular display system, comprising displaying an environment including a plurality of real-world arguments as captured by an imaging device, using a sensor of a microdisplay in a monocular or binocular display, observing eye movement including pupil and iris data while displaying a representation of the environment. The method may further comprise determining, using a processor and based on metrics of the observed eye movement, an emotional state of the user, including whether a fight or flight response is occurring. The method may further comprise adjusting settings of the display based on the emotional state, including increasing brightness for a flight response, decreasing brightness for a fight response, or other setting adjustments.

In another aspect, the invention may comprise a method for vision compensation in a monocular or binocular display system, comprising calibrating the display system to a user to determine whether a vision correction is needed, the calibrating producing calibration data, and adjusting a focus of the display system based on the calibration data.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a block diagram illustrating example embodiments of an embedded image sensor tracking pupil and/or iris parameters assisted via AI processor with predictive methods.

FIG. 1B is a diagram illustrating example embodiments of method of collecting and processing pupil and/or iris data.

FIG. 1C is a diagram illustrating example embodiments of a method of collecting and processing pupil and/or iris data.

FIG. 2 is a diagram illustrating example embodiments of a display system with a sensor in a single device.

FIG. 3A is a diagram of an embedded image sensor in color LCD, OLED, or MicroLED with per pixel microlens to reduce size and weight.

FIG. 3B is a diagram of one or more pixels as described in relation to FIG. 3A.

FIG. 3C is a diagram illustrating sensor pixels on a same chip but adjacent to the display pixels.

FIG. 4 is a diagram of example embodiments of an embedded image sensor in monochrome LCD, OLED, or MicroLED with per pixel microlens to reduce size and weight.

FIG. 5 is a diagram illustrating example embodiments of an embodiment in a see-through eyepiece design with an integrated eye tracker that folds in from the bottom and utilizes a beamsplitter from the eyepiece to view the pupil of the eye.

FIG. 6 is a diagram illustrating example embodiments of an artificial intelligence (AI) method employing independent left and right iris and pupil data from embedded sensors to provide user-specific and eye-specific output imagery.

FIG. 7 is a diagram illustrating example embodiments of an artificial intelligence (AI) method employing an on-silicon or embedded wavefront sensor to measure a user's visual acuity to provide for a vision corrected display system without the need for custom optics, where each eye can be individually controlled.

FIG. 8 is a flow diagram illustrating example embodiments of an embodiment of a method of vision calibration to adapt for vision correction.

FIG. 9 is a diagram illustrating example embodiments of an artificial intelligence processor to predict fight or flight reaction based on changes in the pupil and/or iris and attenuating the display brightness accordingly.

FIG. 10 is a diagram illustrating example embodiments of employing user eye focus and gaze data to create a feedback loop to the AI processor for correct target identification.

FIG. 11 is a diagram illustrating example embodiments of using pupil and iris data to provide an adjusted image on a display.

FIG. 12 is a diagram illustrating example embodiments of AR/VR causing various types of motion sickness and or user discomfort due to the inability to address eye movement frequency and saccade.

FIG. 13 is a diagram illustrating example embodiments of a predictive biologic insights AI method converting observed data and higher order metrics converted into other data.

FIG. 14 is a diagram illustrating example embodiments of natural high frequency low amplitude vibrations can occur naturally in a user's environment, using vibration sensors mounted to the display system, the AI processor is able to automatically apply an inverse vibration to the display system to cancel unwanted vibrations experienced by the user.

FIG. 15 is a diagram illustrating example embodiments of types of models employed by embodiments of the present disclosure.

FIG. 16 is a flow diagram illustrating example embodiments of the present disclosure.

FIGS. 17A and 17B illustrate example embodiments of a microdisplay that incorporates light sensing elements and both visible light and infrared illumination pixels.

FIG. 18 is a diagram of an example internal structure of a computer (e.g., client processor/device or server computers) in the computer system of FIG. 17.

### DETAILED DESCRIPTION

A description of example embodiments follows.

Currently, manual adjustments are required by a user of an AR/VR/MR headset or head mount display system requiring the user to manually adjust the brightness, contrast, and focus/size/distance from the users' eyes to the microdisplay. Existing systems provide no feedback to the user on how far the user's headset/display system should be distanced from the users' eyes.

Currently, dynamic controls of AR/VR/MR headsets and/or head mounted displays are adapted by ambient lighting which is susceptible to many physical factors like clouds, lights turning on and off and user's clothing (hooded sweaters, etc.)

Current artificial intelligence targeting systems do not account for a difference between a user's eye direction and focus versus the Artificial Intelligence target.

Currently, there is no ability to dynamically change or adjust multiple displays by a user of an AR/VR/MR headset or head mount display system requiring the user to manually adjust the brightness, contrast, and focus/size/distance from the users' eyes to the microdisplay(s) other than ambient light sensing or timing.

In some embodiments, the disclosure herein provides the following novel methods and corresponding systems that improve on the above current systems and methods.
a) The method and process for real time pupil tracking and size measurement using an imager (e.g., camera) embedded in a MicroDisplay or Microdisplay subassembly.
b) The method and process for real time pupil tracking and size measurement using an imager (e.g., camera) embedded in a MicroDisplay or Microdisplay subassembly to dynamically control the MicroDisplay brightness, contrast, image frequency, resolution, color, and image focus.
c) The method and process for real time iris tracking and size measurement using an embedded imager (e.g., camera) with a MicroDisplay or Microdisplay system.
d) The method and process for Inferred Pupil Tracking and size measurement. using an embedded imager (e.g., camera) with a MicroDisplay or Microdisplay system
e) The method and process for inferred iris tracking and size measurement. using an embedded imager (e.g., camera) with a MicroDisplay or Microdisplay system
f) The method and process for Measurement and Inferred controls per eye in a dual eye application for heads-up display and AR/VR goggles derived from using an embedded imager (e.g., camera) with a MicroDisplay or Microdisplay system.
g) The method and process for target versus pupil & iris tracking in real time and inferred difference
h) The method and process for eye range to microdisplay measurement using camera using embedded imager (e.g., camera) with a MicroDisplay or Microdisplay system.
i) The method and process for measuring, tracking, and inferring the size, location and future location of a user's pupil and iris through inverse/reverse optics.
j) The method and process for adapting focus, image size, color, contrast, and image brightness of one or several MicroDisplays using real time or inferred pupil and iris size, location, and tracking.
k) The method and process for measuring the distance between one or several Microdisplays to a user's pupil using real time or inferred information from an embedded or external camera.
l) The method and process for measuring the frequency of a human eye movement using an embedded camera.

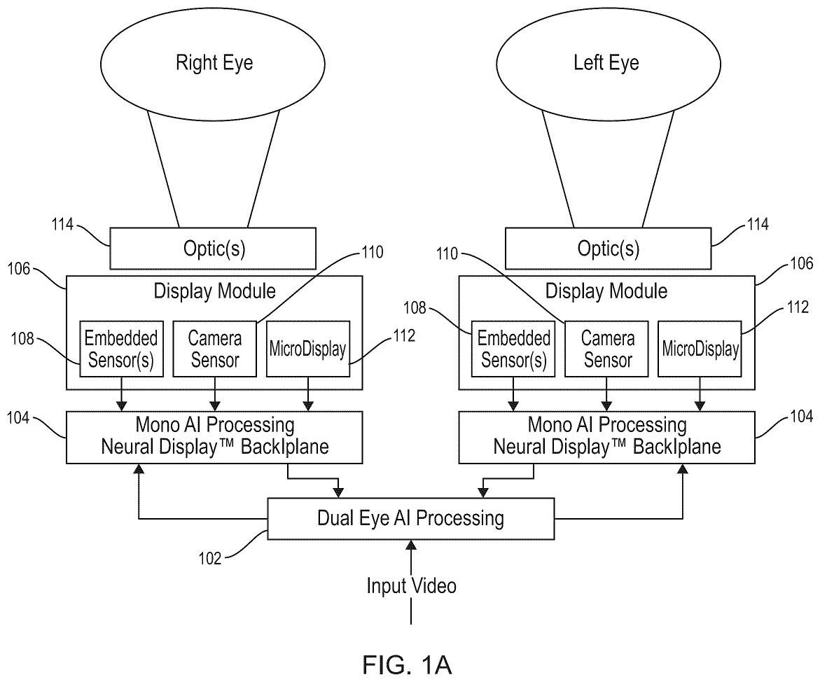

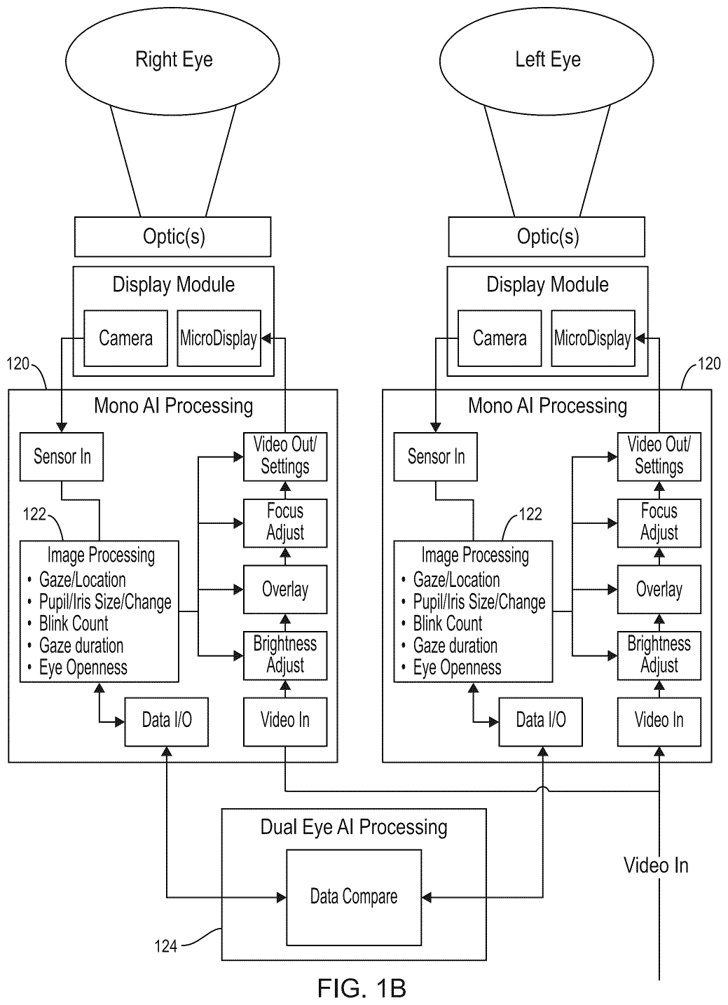

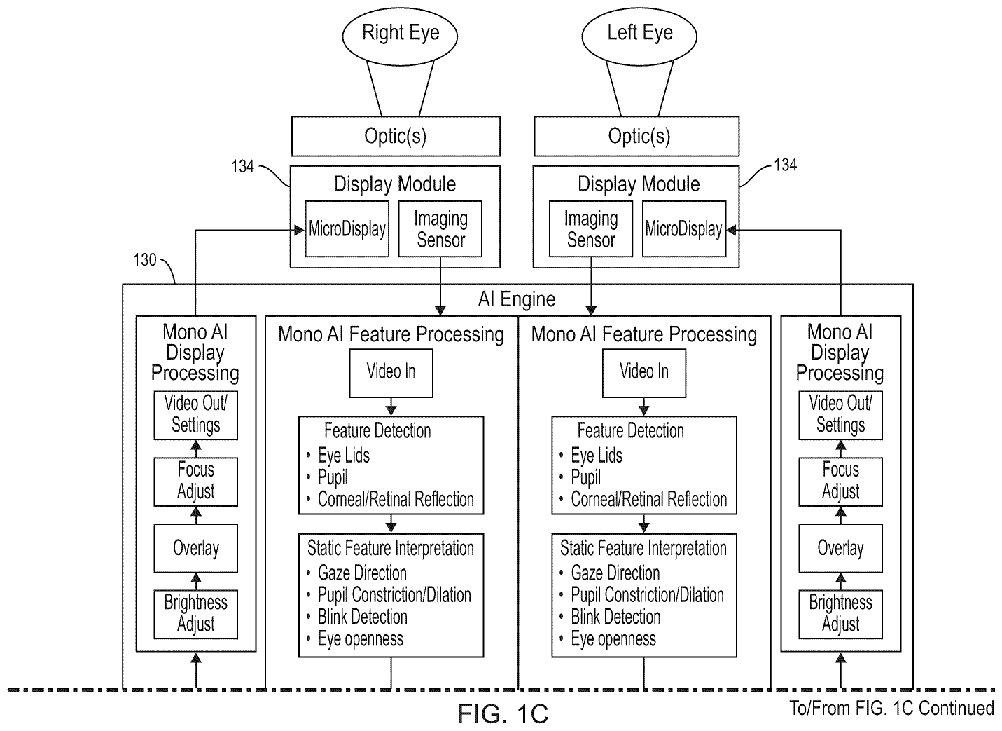

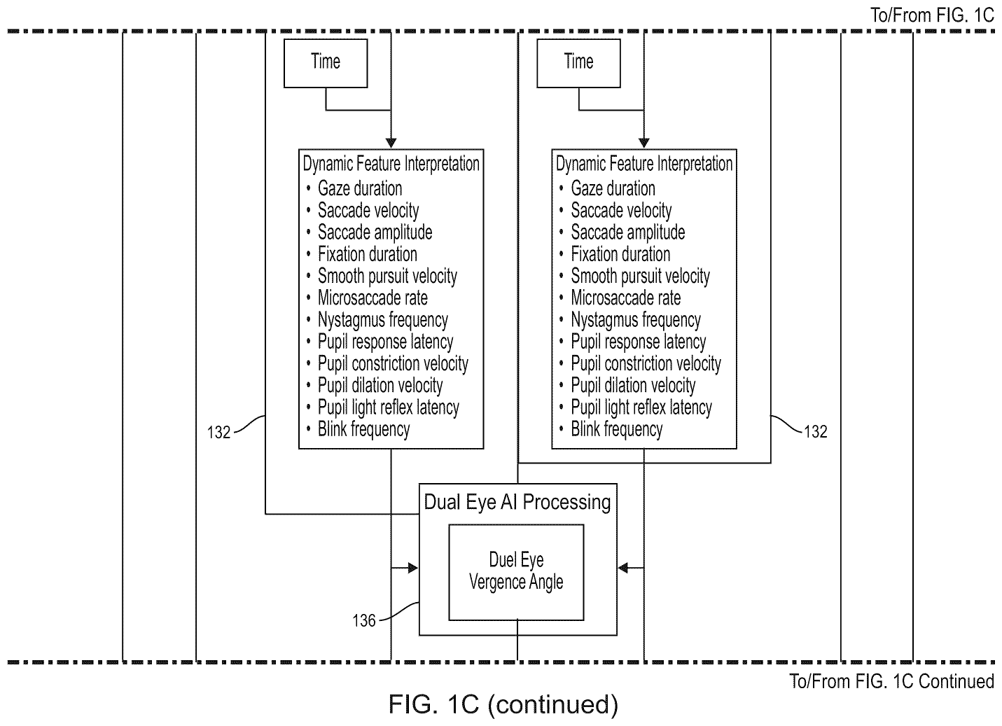

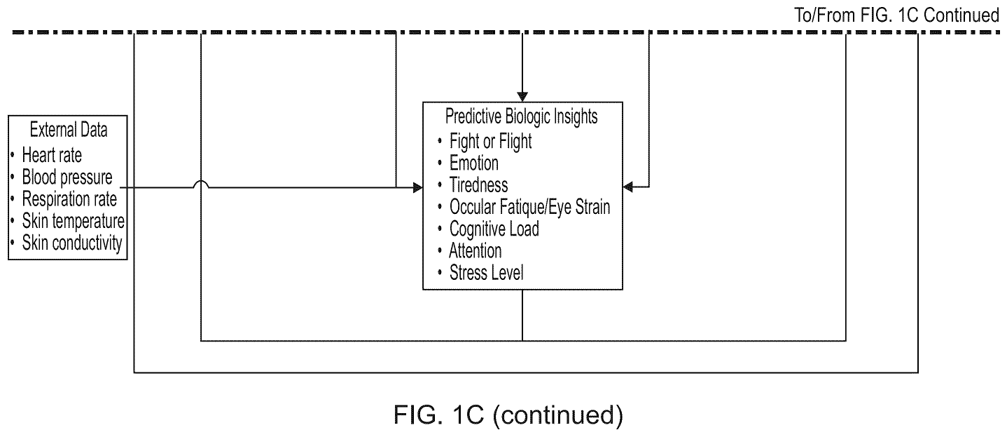

FIG. 1A is a block diagram, according to an example embodiment, illustrating embedded image sensor tracking pupil and/or iris parameters assisted via AI processor with predictive methods. A dual-eye processing module or dual-eye AI processing module 102 receives an input video and exchanges information with a display backplane 104 (e.g., mono processing neural display backplane modules corresponding with each eye's optics). A display module 106 is coupled with each respective backplane module. The display module includes embedded sensor(s) 108, a camera sensor 110, and a microdisplay 112. The display module 106 is further coupled with electronically controllable/adjustable optic(s) 114 that are configured for the respective left and right eye of the user. The electronically controllable/adjustable optic(s) 114 can be adjusted for the user's eye to correctly and clearly see image projected by the microdisplay 112 and so that the camera sensor 110 and embedded sensor(s) 108 can correctly acquire data from the user's eyes (e.g., pupil and iris data).

FIG. 1B is a diagram, according to an example embodiment, illustrating a method of collecting and processing pupil and/or iris data. The respective mono (AI) processing modules 120 are configured to continually monitor the user's eye during display of information. A video microdisplay in the display module receives image data to be displayed to the user's respective eyes. However, instead of directly displaying the raw video, an image processing module 122 adjusts the video/image based on gaze/location, pupil and/or iris size and/or change, blink count, gaze duration, and eye openness. Then the dual-eye processing module 124 compares the two processed images/videos. Meanwhile, the mono processing modules 120 perform brightness adjustment, may add an overlay to the image, adjust the focus, and output the video to the microdisplay, and display to the user through the optics. A person of ordinary skill in the art can recognize that these operations may be performed in other orders, or in parallel. The processing can continue for each frame displayed on the microdisplay. In some embodiments, the processing can continue for only some frames, or more often than once a frame.

FIG. 1C is a diagram, according to an example embodiment, illustrating a method of collecting and processing pupil and/or iris data. A processing engine 130 (e.g., AI engine) includes respective mono (AI) display processing engine(s) 132 and mono (AI) feature processing engines 134 respective to display modules 134 for each eye. The AI Engine receives external data such as heart rate, blood pressure, respiration rate, skin temperature, and/or skin conductivity at a predictive biologic insights module. The predictive biologic insights module determines a prediction of metrics such as a fight or flight response, an emotion, tiredness, ocular fatigue/eye strain, cognitive load, attention, and/or stress level based on the external data and the dual-eye (AI) processing of the dual-eye vergence angle. The mono (AI) display processing engines 132 further perform brightness adjustment, overlay adjustment, focus adjustment, and outputs one or more of an output video and/or settings for the display module and/or optics. In some embodiments, the processor can provide parallax adjustment. The processing engine 130 aligns multiple image sensors or creates a map of object distances in the real world, using vergence data rather than a depth sensor. A person of ordinary skill in the art can understand that vergence is the simultaneous movement of the pupils of the eyes toward or away from one another during focusing.

The microdisplay of the display module 134 then displays the video out at the outputted settings. As the video is being displayed, an imaging sensor observes the user's eyes (e.g., pupils, iris) and provides that sensed data to the mono feature processing module 132. The mono (AI) feature processing modules 132 further receive a video in file/feed/stream to be adjusted and displayed to the user. The mono feature processing module 132 includes a feature detection module that detects a user's eye lids, pupil, and corneal/retinal reflection from the imaging sensor data. The mono featuring processing module 132 further includes a static feature interpretation module that detects a gaze direction, pupil constriction/dilation, blink detection, and eye openness. The mono feature processing module 132 further includes a dynamic feature interpretation module that determines gaze duration, saccade velocity, saccade amplitude, fixation duration, smooth pursuit velocity, micro-saccade rate, Nystagmus frequency, pupil response latency, pupil constriction velocity, pupil dilation velocity, pupil light reflex latency, and/or blink frequency. The result of the processing is fed to the dual-eye processing module 136 and the predictive biologic insights module and is employed to generate those outputs.

As described above relating to the systems of FIGS. 1A-C, pupils are measured, and the following parameters are quantified as high-level features such as: gaze duration, saccade velocity, saccade amplitude, fixation duration, smooth pursuit velocity, micro-saccade rate, nystagmus frequency, pupil response latency, pupil constriction velocity, pupil dilation velocity, pupil light reflex latency, and/or blink frequency, among others.

The pre-processing methods and modules (e.g., mono processing neural display backplane 104, mono processing 120, mono feature processing 132) include parameter extraction and normalization (e.g., sensor data about the user responding to the video). Data collection occurs and provides the raw data. Low level feature extraction provides information such as fixation, saccades, gaze, etc. High level features can then be extracted. These high level features can be referred to as processed parameters that are inputs into a predictive biologic insight AI model using neural networks (NNs) and binary decision tree for the classification tasks. The various AI models include K-nearest Neighbor, support vector machine (SVM), Hidden Markov Model, Binary decision tree, Naïve Bayes, and/or Random Forest, and other such models known in the art going forward.

The predictive biologic insight AI model is trained on a large variety of existing and custom labeled data sets. Custom labeled data sets can be derived from simulated conditions such as first-person shooter (FPS) video game inputs and flight simulators. These custom data sets can be used on separate models, or to finetune the predictive biologic insight AI model. Supervised learning can be adjusted to correct for the feature extraction. This provides a trained model that provides information such as: fight or flight response, emotion, tiredness, ocular fatigue/eye strain, cognitive load, attention, stress level, and/or applications, as shown by FIG. 1C.

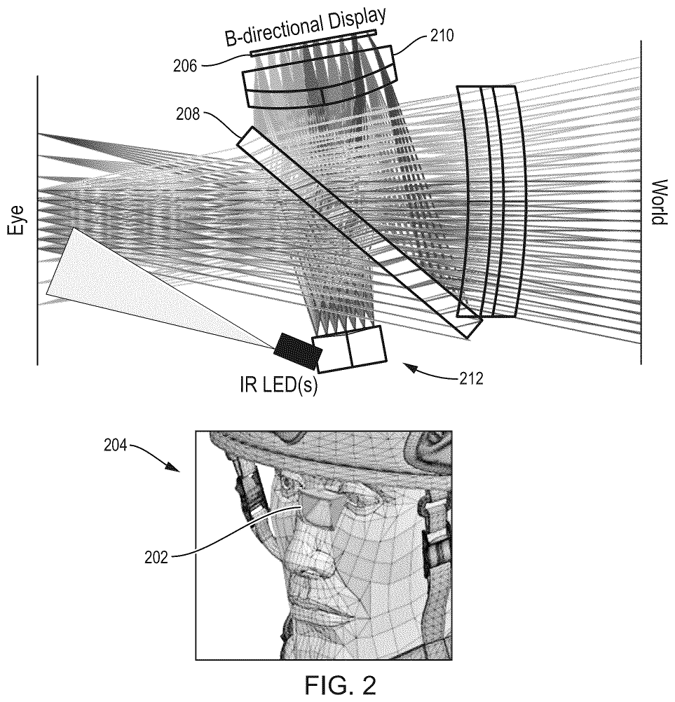

FIG. 2 is a diagram, according to an example embodiment, illustrating embodiments of a display with a sensor in a single device. The display 202 is worn over the user 204, show by FIG. 2 as being over one eye. However, a person of ordinary skill in the art can recognize that the display can be employed in both a monocular and binocular (e.g., over both eyes) embodiment. A microdisplay 206 is provided to operatively display information to the user's pupil in conjunction with an electrically controlled mirror 208 and focusing lens 210. In addition, an imaging sensor 212, in conjunction with its own focusing lens and the electronically controlled mirror, monitors the pupil.

In these embodiments, the imaging sensor is positioned in a different plane than the microDisplay. These embodiments allow for an augmented reality design in which the user can overlay the displayed image over their real-world vision. These embodiments leverage an electronically controlled mirror (e.g., piezo or MEMS) that allows for real time changes to where the imaging sensor is imaging. Therefore, the system can track eye/eye-ball movements and adjust the mirror.

In some embodiments, the plane of focus of the sensor is different from the plane of focus of the pixels. For example, in some embodiments, the plane of focus of the display is the retina, and the plane of focus of the sensor is the cornea/pupil/iris.

These embodiments allow for a direct view of the pupil without being blocked by the eyelids when the eye looks downwards. In other embodiments, the imaging sensor is located lower looking upwards at the pupil. Being able to always see the pupil as straight on as possible, as in the current embodiments, yield the least amount of distortion and captures the best data for analysis.

These embodiments also allow for the imaging sensor to be of lower resolution as the pupil is always in the maximum field of view. Therefore, the system can increase capture frame rate without significantly increasing the total data bandwidth that needs to be processed in real-time.

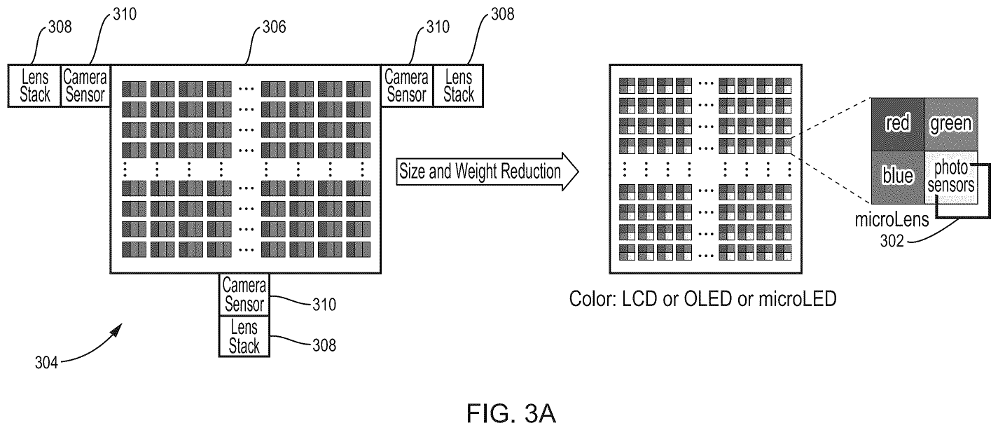

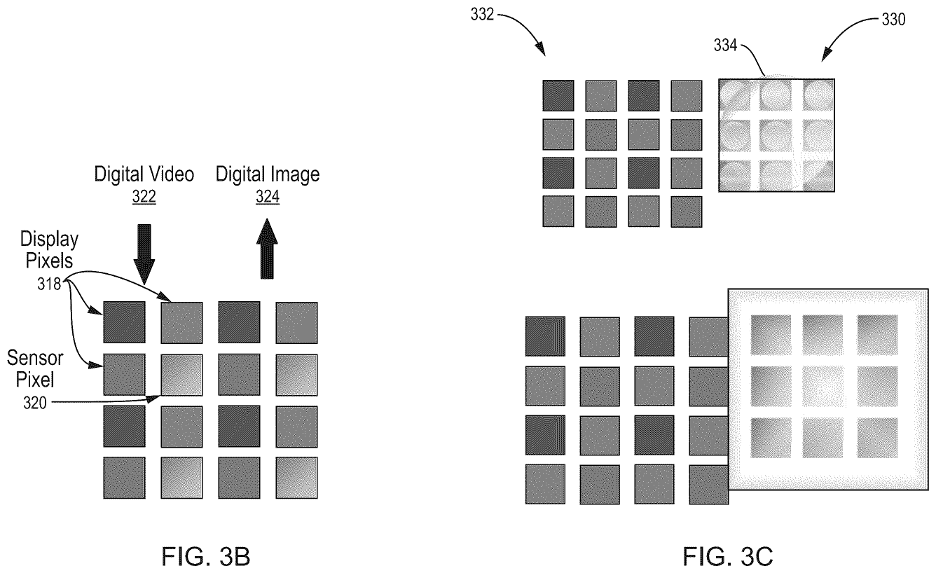

FIG. 3A is a diagram, according to an example embodiment, of an embedded image sensor in color LCD, OLED, or MicroLED with per pixel microlens 302 to reduce size and weight. An embedded sensor 304, as shown in the left, includes a display unit 306 with red, green, and blue (RGB) pixels with one or more separate lens stack(s) 308 and corresponding camera sensor(s) 310. Such a setup takes up additional size and weight, which is disadvantageous in head mounted displays, when reducing size and weight is at a premium.

Advantageously, this disclosure provides a novel display made of a plurality of pixels, each pixel including at least one display pixel and one microlens photo sensor. In this way, the display element and sensing element are part of the pixel. In addition to reducing space, this provides for sensing in the same plane/location as the light is emitting from. In FIG. 3A, the photo elements are shown to be a red pixel, a green pixel, and a blue pixel, along with a microlens photo sensor.

FIG. 3B is a diagram, according to an example embodiment, of one or more pixels as described in relation to FIG. 3A. The display pixels 318 are red, green, and blue (RGB) pixels, but could be other colors or monochrome. A sensor pixel 320 corresponds with all or at least a portion of the RGB pixels. A digital video 322 or image representation is input to the collection of pixels, and in response a digital image or sequence of images (video) is output. At the same time, the sensor pixel can sense data (e.g., pupil or iris information, or other information) while the display pixels 318 are projecting image data 324.

FIG. 3C is a diagram, according to an example embodiment, illustrating sensor pixels 330 on the same chip but adjacent to the display pixels 332. In FIG. 3C, top, the system optics are imaging the display pixels onto the image plane. Lens elements 334, over sensor pixels individually or over groups of sensor pixels, adjust the sensor focus distance to match the front of the user's eyeball.

In another embodiment, wavefront encoding optics may be placed over individual sensor pixels or groups of pixels (bottom). Wavefront encoding optics, when combined with digital image processing, may enable extended focus depth, thus allowing the sensor pixels to image the front of the eyeball simultaneously with projecting the display image onto the user's retina.

In these embodiments, the wavefront optics apply an optical transfer function (OTF) to the image, presenting a “blurred” image to the sensor array. The system electronics digitally apply the inverse transform, resulting in an image of the iris and pupil that is relatively invariant to the focus of the optical imaging system.

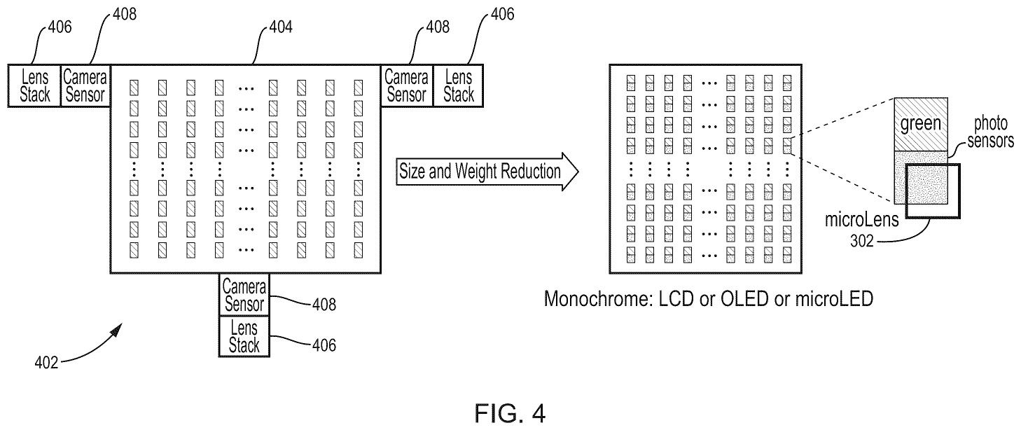

FIG. 4 is a diagram of an example embodiment of an embedded image sensor in monochrome LCD, OLED, or MicroLED with per pixel microlens to reduce size and weight. An embedded sensor 402, as shown in the left, includes a display unit with monochrome (e.g., green or other color) pixels 404 with one or more separate lens stack(s) 406 and corresponding camera sensor(s) 408. Such a setup takes up additional size and weight, which is disadvantageous in head mounted displays, when reducing size and weight is at a premium.

Advantageously, this disclosure provides a novel display made of a plurality of pixels, each pixel including at least one display pixel and one microlens photo sensor. In this way, the display element and sensing element are part of the pixel. In addition to reducing space, this provides for sensing in the same plane/location as the light is emitting from. In FIG. 4, the photo elements are shown to be a monochrome pixel, along with a microlens photo sensor.

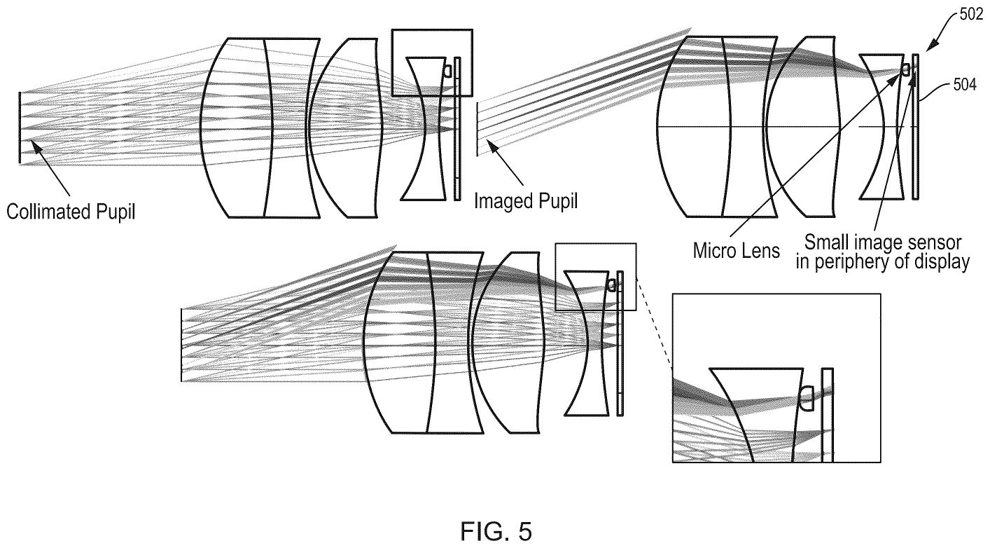

FIG. 5 is a diagram, according to an example embodiment, illustrating an example embodiment as a see-through eyepiece design with an integrated eye tracker that folds in from the bottom and utilizes a beamsplitter from the eyepiece to view the pupil of the eye. The pupil plane and image/display plane are anti-conjugate. It is desirable to have the sensor 502 and display 504 be co-located on the backer board. An additional lens/micro-lens between the sensor and eyepiece can be necessary to image the pupil.

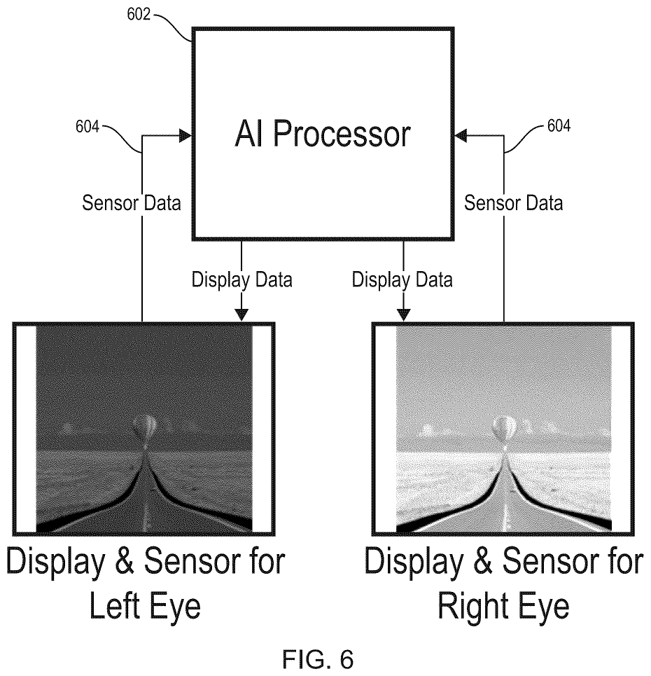

FIG. 6 is a diagram, according to an example embodiment, illustrating an example artificial intelligence (AI) method employing independent left and right iris and pupil data from embedded sensors to provide user-specific and eye-specific output imagery. The AI processor 602 can, in embodiments, be a processor configured to employ an AI method, or a specifically designed processor for AI methods. The AI processor receives sensor data 604 (e.g., pupil and iris data, brightness data, etc.) for each respective eye. The AI processor then adjusts the display for each respective eye in response to the sensor data. The AI processor continues to adjust the display in response to sensor data.

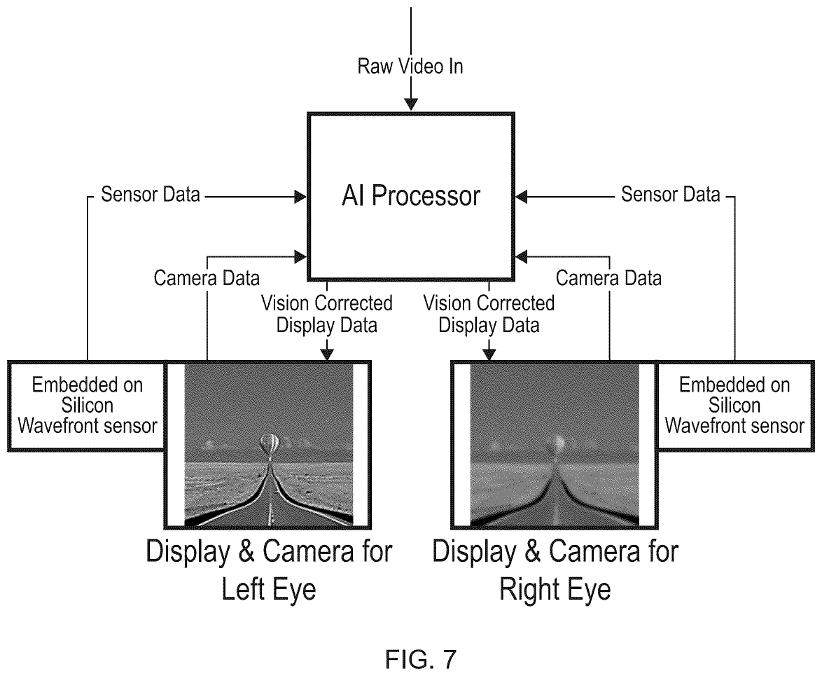

FIG. 7 is a diagram, according to an example embodiment, illustrating an artificial intelligence (AI) method employing an on-silicon or embedded wavefront sensor to measure a user's visual acuity to provide for a vision corrected display without the need for custom optics, where the optical path to each eye can be individually controlled. The AI processor can, in embodiments, be a processor configured to employ an AI method, or a specifically designed processor for AI methods. The AI processor receives sensor data (e.g., pupil and iris data, brightness data, etc.) for each respective eye as well as a raw video feed input. The AI processor then adjusts the display of the raw video feed for each respective display in response, displaying a modified video for each eye. The AI processor continues to adjust the display in response to sensor data, and further adjusts each image for vision corrected display data (e.g., eyesight, astigmatism, etc.).

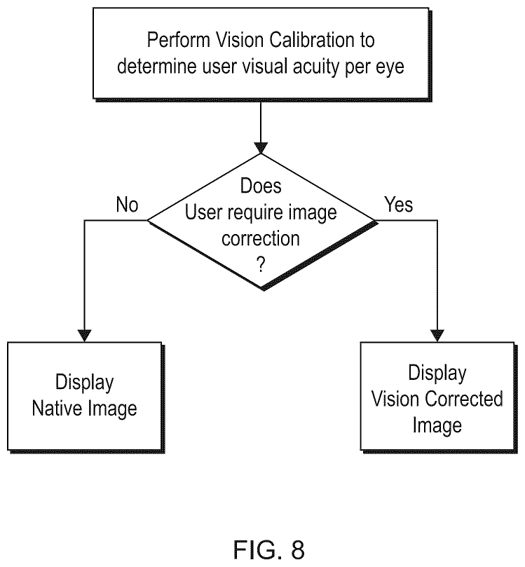

FIG. 8 is a flow diagram, according to an example embodiment, illustrating an embodiment of a method of vision calibration to adapt for vision correction. The method begins by performing a vision calibration to determine user visual acuity per eye. If the user requires image correction, the system processes and displays a vision-corrected image. If the user does not require image correction, the system displays a native image. This procedure can be repeated periodically to determine change in user status (e.g., new user wearing the headset, a user's glasses or contacts were removed, etc.).

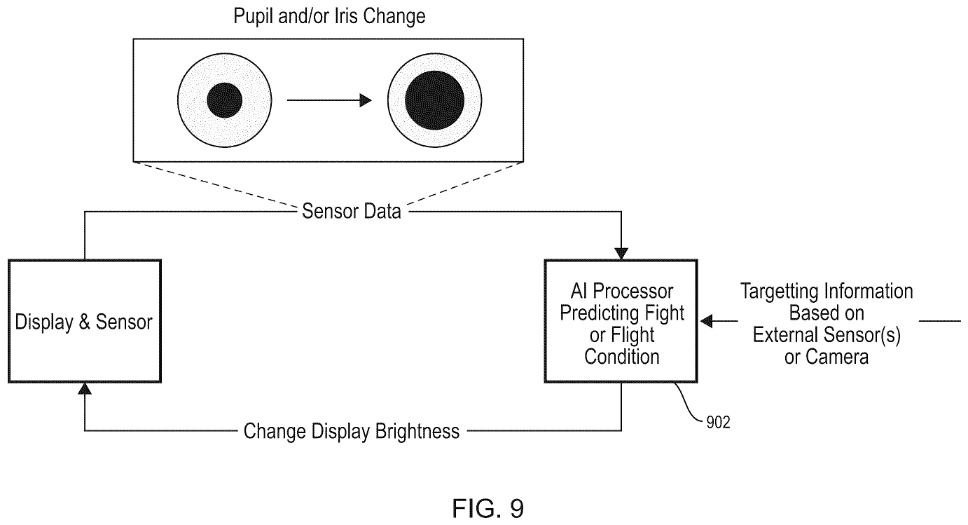

FIG. 9 is a diagram, according to an example embodiment, illustrating an artificial intelligence processor 902 to predict fight or flight reaction based on changes in the pupil and/or iris and adjust the display brightness accordingly. A model receives targeting information based on sensors (e.g., radar, lidar, or other sensors) and/or a camera. Based on this targeting information combined with sensed information about pupil and/or iris data, the model can determine whether the user is or will be exhibiting a fight or flight response. As a result, the user can adjust the display to help the user deal with the fight or flight response. For example, when a user's pupil begins to grow, that is an indication that the user is entering a fight response. In the flight context, if a pilot is about to fight, often they remove their head-mounted display because the display appears too bright in that moment due to the pupil growing. However, this model of this example embodiment can predict and respond by automatically lowering the brightness in such a scenario so that the user keeps their head mounted display on. In a situation where the flight response is happening, brightness can be increased.

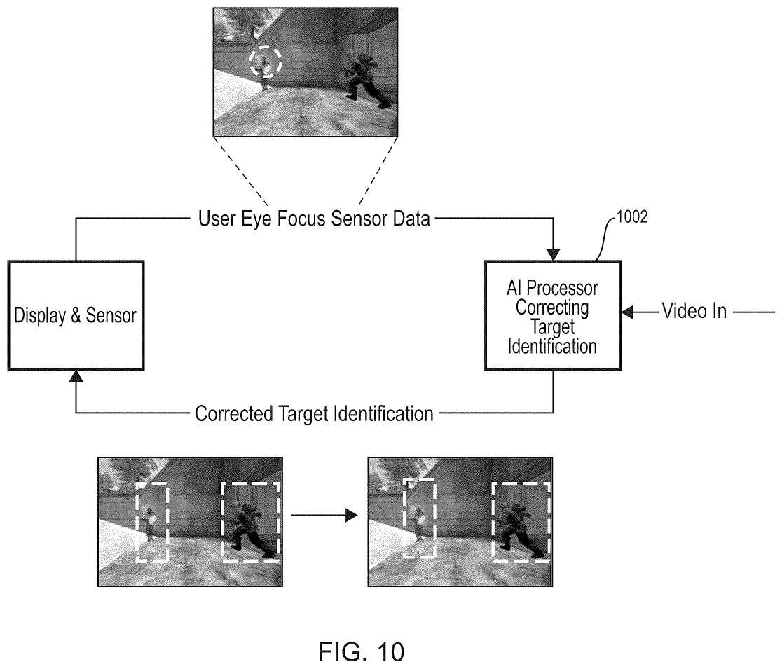

FIG. 10 is a diagram, according to an example embodiment, illustrating employing user eye focus and gaze data to create a feedback loop to the AI processor 1002 for correct target identification. In this diagram, the system initially incorrectly identified two threats, whereas the user correctly identified the single threat. The AI model receives the user's eye data, as well as the video feed, and determines only one of the targets is a threat. Target tracking can be determined by tracking eye movement across the field of view and comparing that movement to either gaze angle or head position, which determines either object size or distance, given that the other is known. The system display is then updated based on the eye data.

In addition, the feedback can be provided to a separate automated targeting system to help it improve (e.g., continuous training via use of the system). The updated model continues to optimize display operation for an interesting or threatening object (e.g. higher frame rate, higher resolution, brighter, etc.).

In some embodiments, a processor can perform environment mapping by tracking a location of an object of interest in the real world. The processor can highlight and quickly reacquire the location of the object if the user looks away and then looks back.

In some embodiments, the processor can perform brightness adjustment based on pupil dilation. Such an adjustment helps solve some problems associated with other automatic brightness adjustment methods. If the brightness of the ambient environment is known, the method could work to adjust brightness of the display and/or other display settings to keep pupil dilation a comfortable level for the user, eliminating time for the eyes to adjust when taking the displays on and off.

In some embodiments, the processor can provide eye protection by sensing sudden pupil constriction and attenuating the display and/or any direct viewing optics.

In some embodiments, the processor can provide adaptive behavior. The system can learn that a certain pattern of eyeball behavior triggers appropriate heads-up display information based on recognition of previous behaviors. For example, the system can learn when a pilot is about to land the plane by learning patterns of brings up context menus for that task, or displays nav charts, etc.

In some embodiments, the processor can provide information delivery. The eye tracking data gauges the amount of information the user is receiving. For example, the processor can adjust the display or focus for “maximum information delivery.”

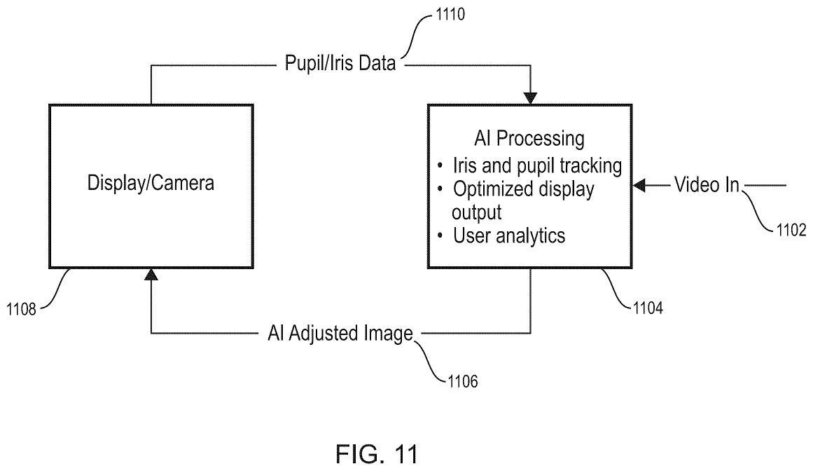

FIG. 11 is a diagram, according to an example embodiment, illustrating AI processing of pupil/iris data. A raw video 1102 is input to the AI processor 1104, which performs iris and pupil tracking. The AI processor 1104 generates an optimized display output (AI adjusted image 1106) and user analytics. The AI adjusted image 1106 is then sent to the display/camera unit 1108, which displays the image while sensing the pupil and iris and collecting pupil and iris data 1110. This procedure then continues, in a loop, as the video feed continues.

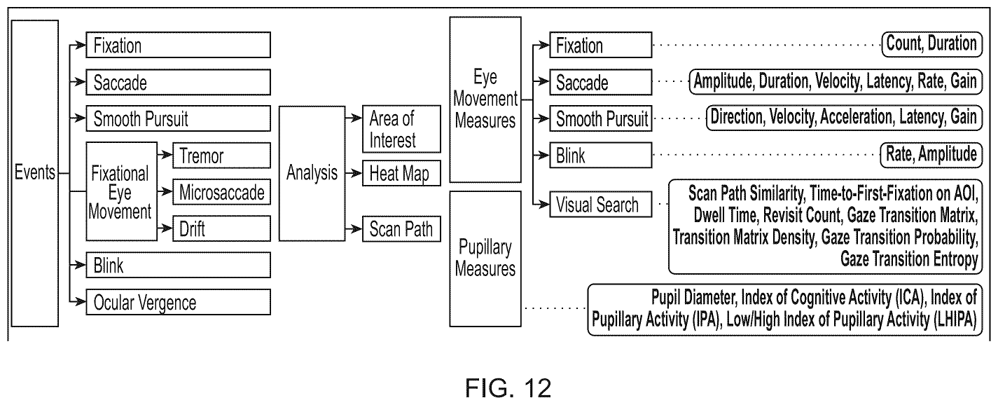

FIG. 12 is a diagram, according to an example embodiment, illustrating that AR/VR can cause various types of motion sickness and or user discomfort due to the inability to address eye movement frequency and saccade. Leveraging deep learning along with data collected from the iris and pupil such as saccade, drift, blink, tremor, gaze, fixation, and pupil size, the displayed images can be adjusted to mitigate these effects. Eye events that can be measured include a fixation, a saccade, a smooth pursuit, fixational eye movements including a tremor, micro saccade, and a drift, a blink, and an ocular vergence. Eye movement measures include a fixation (count, duration), a saccade (amplitude, duration, velocity, latency, rate, gain), a smooth pursuit (direction velocity, acceleration, latency, gain), a blink (rate, amplitude), and visual search (scan path similarity, time-to-first-fixation on area of interest (AOI), dwell time, revisit count, gaze transition matrix, transition matrix density, gaze transition probability, gaze transition entropy). Pupillary measures include pupil diameter, index of cognitive activity (ICA), index of pupillary activity (IPA), low/high index of pupillary activity (LHIPA).

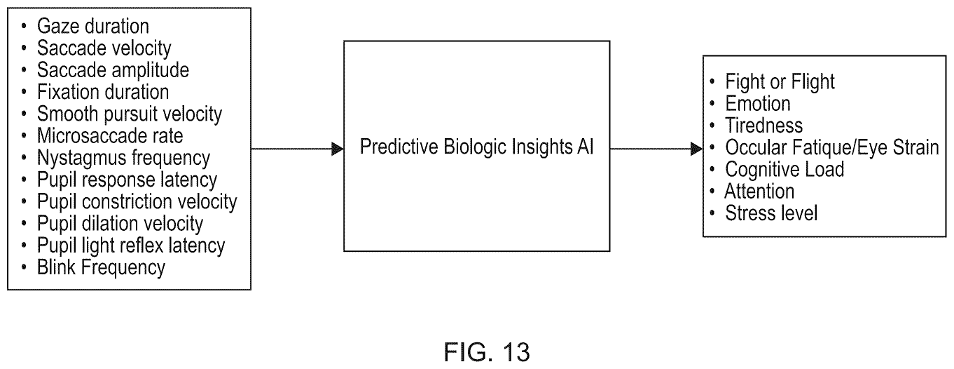

FIG. 13 is a diagram, according to an example embodiment, illustrating the predictive biologic insights AI method converting observed data and higher order metrics converted into other data. The processor can, based on gaze duration, saccade velocity, saccade amplitude, fixation duration, smooth pursuit velocity, microsaccade rate, nystagmus frequency, pupil response latency, pupil constriction velocity, pupil dilation velocity, pupil light reflex latency, and blink frequency determine metrics about the user, such as fight or flight response, emotion, tiredness/fatigue, ocular fatigue/eye strain, cognitive load, attention, and stress level.

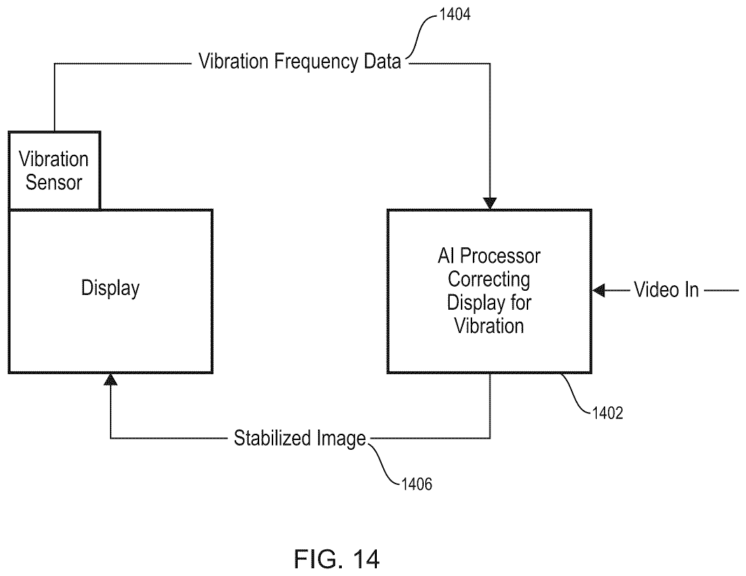

FIG. 14 is a diagram, according to an example embodiment, illustrating the use of natural high frequency, low amplitude vibrations that can occur naturally in a user's environment. Using information 1404 from vibration sensors mounted to the display, the AI processor 1402 of this embodiment automatically applies an inverse vibration to the display to cancel unwanted vibrations experienced by the user. Alternatively, the AI processor 1402 may apply the inverse digital vibration to the received video, thereby sending a stabilized image 1406 to the display.

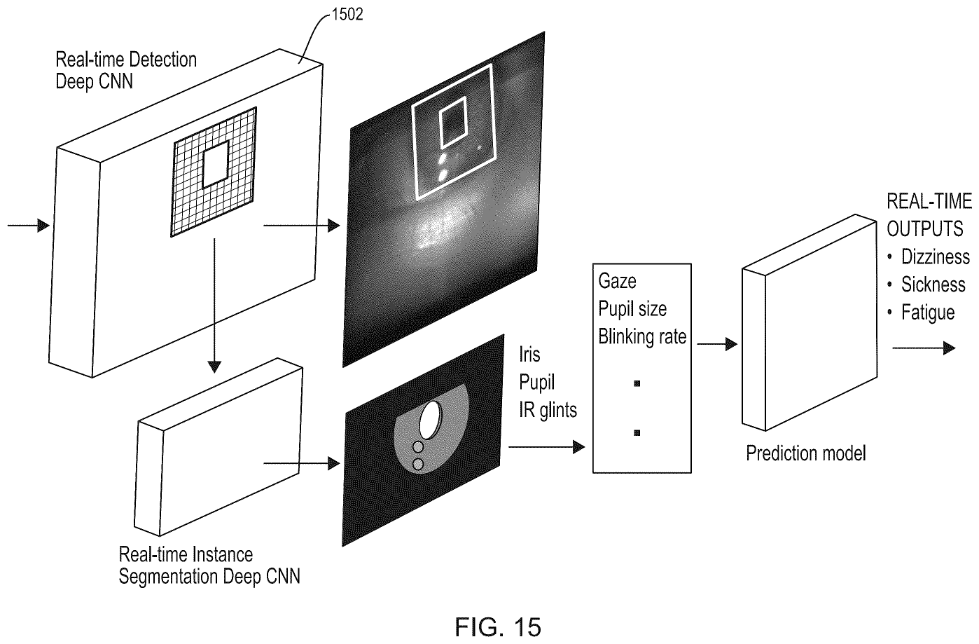

FIG. 15 is a diagram illustrating processing flow of one or more example embodiments described herein, including a real-time detection deep convolutional neural network (CNN) 1502, a real-time instance segmentation deep CNN 1504, and a prediction model 1504.

Types of models employed by embodiments of the present disclosure may include machine learning methods and models such as K-nearest neighbor, support vector machine, hidden Markov model, decision tree, naïve bayes, and random forest. The pre-processing procedure includes parameter extraction and normalization. These processed parameters will be inputs into a Predictive Biologic Insight AI model using neural networks (NNs) and binary decision tree for the classification tasks. The Predictive Biologic Insight AI model can be trained on a large variety of existing and custom labeled data sets. Custom labeled data sets can be derived for simulated conditions such as first person shooter (FPS) video game inputs and flight simulators.

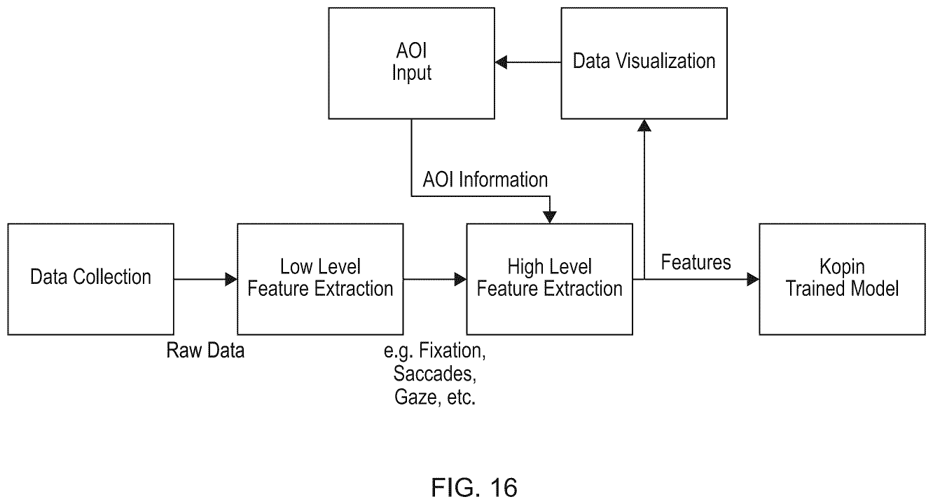

FIG. 16 is a flow diagram illustrating embodiments of the present disclosure. Data collection occurs and provides the raw data (e.g., from the sensor systems described above). Low Level feature extraction from the data collection provides information such as fixation, saccades, gaze, etc. High Level features can then be extracted from the low level features also using area of interest (AOI) input. This can be then visualized in supervised learning and the AOI can be adjusted to correct for the feature extraction. The trained model that results can then provide a user behavior characteristic such as fight or flight, emotion, tiredness, ocular fatigue/eye strain, cognitive load, attention, stress level.

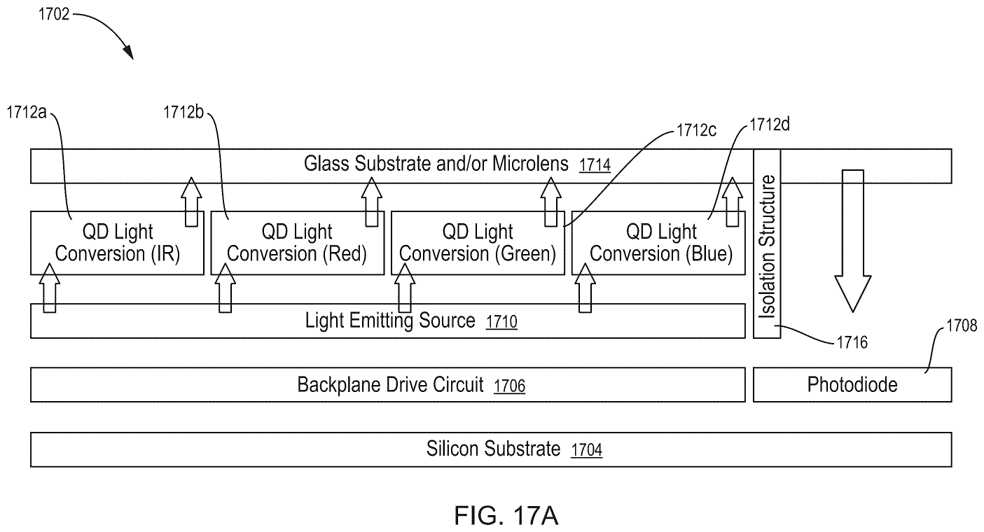

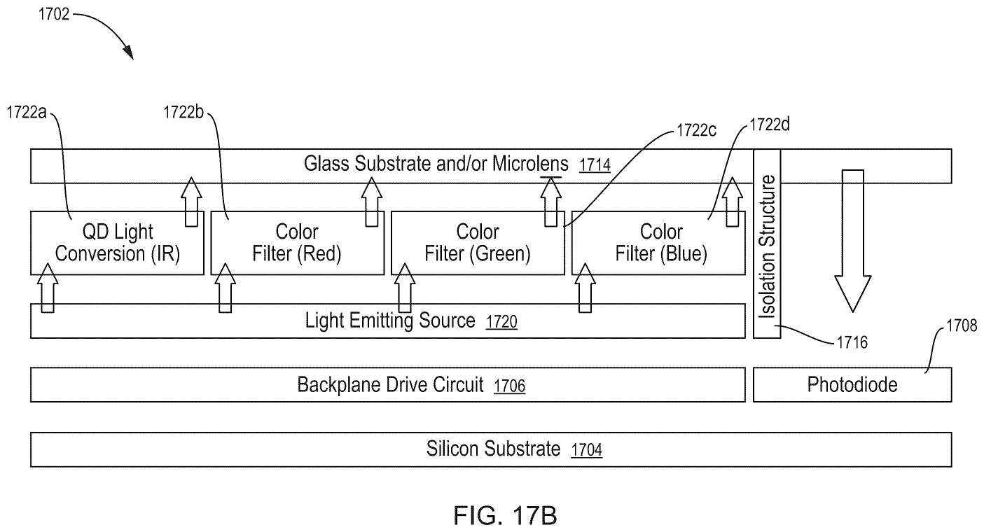

An example embodiment of a display system may comprise image sensor elements that are sensitive to visible and non-visible wavelengths. Quantum dots may be used to convert visible or UV light from the microdisplay to provide near-visible infrared NIR) or short-wave infrared (SWIR) illumination for the sensor. The display system can provide uniform IR illumination, or it can be used to project specific infrared test patterns onto the eye. For example, the display system can project an infrared grid pattern onto the surface of the eye, and the sensor pixels can detect the reflected image of this grid pattern to facilitate mapping the curvature of the eyeball. FIG. 17A illustrates an example embodiment of a microdisplay that incorporates such light sensor elements and both visible light quantum dots and non-visible light quantum dots. The microdisplay 1702 of this embodiment comprises a silicon substrate 1704 supporting a backplane drive circuit 1706 and a light sensor (e.g., photodiode) 1708. A light emitting source 1710 (e.g., an array of visible light pixels) is situated on the backplane drive circuit 1706. An example set of four quantum dots (QDs) is situated on the light emitting source 1710. Each QD 1712a, 1712b, 1712c, 1712d converts visible light from the light emitting source 1710 to light of a specific wavelength. In this example, QD 1712a converts input light to IR light, QD 1712b converts input light to red light, QD 1712c converts input light to green light, and QD 1712d converts input light to blue light. A glass substrate and/or microlens 1714 is situated atop the QDs. An isolation structure 1716 may be used to isolate light from the light emitting source 1710 and QDs 1712a, 1712b, 1712c, 1712d from the photodiode 1708.

FIG. 17B illustrates a microdisplay similar to the microdisplay shown in FIG. 17A, except that the light emitting source 1720 is an OLED source that emits white light, and includes a red color filter 1722b, a green color filter 1722c, and a blue color filter 1722d in place of the QDs 1712b, 1712c, 1712d to produce red, green, and blue light, respectively. The QD 1722a converts the white light from the OLED source 1720 to IR light.

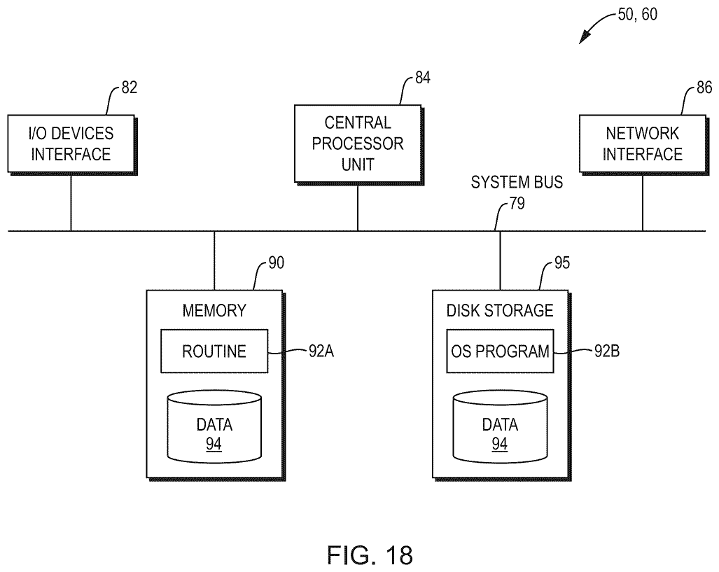

FIG. 18 is a diagram of an example internal structure of a computer (e.g., client processor/device 50 or server computers 60) in the computer system of FIG. 17. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 17). Memory 90 provides volatile storage for computer software instructions 92 and data 94 used to implement an embodiment of the present invention (e.g., dual-eye processing module, mono processing neural display backplane module, data compare module, mono processing module, display module, mono feature processing module, AI engine module described above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92. Further details and examples are provided in Appendix A and Appendix B.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A display system, comprising:
an array of pixels arranged to display an image;
one or more imaging sensors, each imaging sensor being arranged with at least one pixel of the array; and
at least one communication line to provide an image to the array of pixels and to output the sensed data of the plurality of imaging sensors.

2. The display system of claim 1, further comprising at least one predictive artificial intelligence model, running on an embedded processor, to gain biological/physiological insights, wherein the one or more imaging sensors acquires at least one dynamic feature of an eye of a user and provides the at least one dynamic feature to the predictive artificial intelligence model, and wherein the at least one dynamic feature to the predictive artificial intelligence model produces therefrom at least one user behavior characteristic.

3. The display system of claim 2, wherein the at least one dynamic feature comprises one or more of gaze duration, saccade velocity, saccade amplitude, fixation duration, smooth pursuit velocity, microsaccade rate, nystagmus frequency, pupil response latency, pupil constriction velocity, pupil dilation velocity, pupil light reflex latency, and blink frequency.

4. The display system of claim 2, wherein the at least one user behavior characteristic comprises one or more of fight or flight response, emotion, tiredness/fatigue, ocular fatigue/eye strain, cognitive load, attention, and stress level.

5. The display system of claim 1, further comprising a first optical channel for processing a video signal to a first eye of a user, a second optical channel for processing the video signal to a second eye of the user, and a dual eye processor that processes aspects of the first optical channel and the second optical channel.

6. The display system of claim 5, wherein the first optical channel, the second optical channel, and the dual eye processing channel utilize artificial intelligence processing techniques.

7. The display system of claim 6, wherein the artificial intelligence processing techniques comprise at least one of K-nearest Neighbor, SVM, Hidden Markov Model, Binary decision tree, Naïve Bayes, and Random Forest.

8. A display system, comprising:
an array of pixels arranged to display an image; and
an array of imaging sensors arranged to operatively detect information from an eye of a user in response to the displayed image of the array of pixels.

9. The display system of claim 8, wherein the array of imaging sensors is arranged to operatively calibrate, optimize, and/or manage one or more characteristics of the array of pixels.

10. The display system of claim 9, wherein the one or more characteristics comprises one or both of brightness and contrast.

11. The display system of claim 8, further comprising an array of infrared illumination pixels, wherein the array of infrared illumination pixels is arranged with the array of pixels such that a quantum dots layer converts light from the array of pixels to emissions in an infrared wavelength spectrum.

12. The display system of claim 11, further comprising one or more sensor pixels that are sensitive to light in the non-visible light wavelength range.

13. The display system of claim 8, wherein the array of imaging sensors is overlaid with one or more lens elements or wavefront encoding optics, such that the wavefront encoding optics can provide vision error measurements.

14. The display system of claim 8, further comprising a first mono-processing channel for processing a video signal to a first eye of a user, a second mono-processing channel for processing the video signal to a second eye of the user, and a dual eye processor that processes aspects of the first mono-processing channel and the second mono-processing channel.

15. The display system of claim 14, wherein the first mono-processing channel, the second mono-processing channel, and the dual eye processing channel utilize artificial intelligence processing techniques.

16. The display system of claim 14, wherein the first mono-processing channel is coupled to a display module, and the second mono-processing channel is coupled to a second display module, wherein the first display module and the second display module comprises a first array of pixels and a camera.

17. The display system of claim 16, wherein the camera of each display module collects information associated with the respective eye of the user and conveys the information to the respective mono processing channel.

18. A monocular or binocular display system, comprising:
an electronically controlled mirror;
a second mirror;
a focusing lens;
a microdisplay configured to project an image to the second mirror, such that it is reflected to the focusing lens; and
an imaging sensor configured to receive images of a pupil reflected off the second mirror and electronically controlled mirror.

19. A method for determining a target, the method comprising:
displaying an environment including a plurality of real-world arguments as captured by an imaging device;
observing, using a sensor of a microdisplay in a monocular or binocular display, eye movement including pupil and iris data while displaying a representation of the environment;
based on metrics of the observed eye movement, using a processor, determining or verifying whether a first real-world object captured by a camera is a target;
updating the display of the environment to indicate the determined or verified target.

20. The method of claim 19, wherein a second real-world object is captured by the camera, and the processor selects one of the first real-world object or the second real-world object as more likely being the target.

21. A method for adjusting a monocular or binocular display system, the method comprising:
displaying an environment including a plurality of real-world arguments as captured by an imaging device;
using a sensor of a microdisplay in a monocular or binocular display, observing eye movement including pupil and iris data while displaying a representation of the environment;
based on metrics of the observed eye movement, using a processor, determining an emotional state of the user, including whether a fight or flight response is occurring;
adjusting settings of the display based on the emotional state, including increasing brightness for a flight response, decreasing brightness for a fight response, or other setting adjustments.

22. A method for vision compensation in a monocular or binocular display system, the method comprising:
calibrating the display system to a user to determine whether a vision correction is needed, the calibrating producing calibration data;
adjusting a focus of the display system based on the calibration data.
